(19) United States
(12) Patent Application Publication
(10) Pub. No.: US 2013/0004628 A1
(43) Pub. Date: Jan. 3, 2013

(54) FOOD PRODUCT KIT

(75) Inventors: Stephanie Brekke Williams, Minnetonka, MN (US); Jessica Ann Welsch, St. Paul, MN (US)

(73) Assignee: THE HOPEFULL COMPANY, INC., Minnetonka, MN (US)

(21) Appl. No.: 13/171,068

(22) Filed: Jun. 28, 2011

(51) Int. Cl. A23L 1/00; G09B 19/00

(52) U.S. Cl. 426/134; 434/127

(57) ABSTRACT

A nutritional system includes a food product kit that can be used to prepare nutritious meals that are easy to eat, such as for those undergoing chemotherapy or diagnosed with dysphagia. The food product kit includes, for example, a mold for forming the food product ingredients into a desired shape while freezing, sticks for providing a handle for the frozen food product, an assortment of recipe cards identifying recipes for the food products, and an insulated tote for storing the kit components and the frozen food products. The food product kit may further include narratives printed on the assortment of recipe cards and a thermal pack for keeping the frozen food product cold. Methods of providing nutritional food products to a recipient are also disclosed.

### BACKGROUND

Each year over 1.1 million individuals in the US are estimated to receive chemotherapy. Additionally, approximately one million Americans receive a new diagnosis of dysphagia (a difficulty swallowing) each year. Such individuals can have difficulty receiving adequate nutrition, and doing so can be uncomfortable or painful.

### SUMMARY

In general terms, this disclosure is directed to a food product kit that can be used to prepare nutritious meals that are easy to eat. In one possible configuration and by non-limiting example, the food product kit includes a mold for forming the food product ingredients into a desired shape while freezing, sticks for providing a handle for the frozen food product, an instruction booklet, and an insulated cooler for storing the kit components and the frozen food products. Some embodiments further include one or more of recipes with color photos and nutritional information, poetic affirmations, mindful eating instructions, and instructions.

One aspect is a nutritional system comprising a mold having a plurality of food product forming cavities; a plurality of sticks sized for insertion into the cavities; a plurality of recipe cards, each recipe card having printed thereon at least one recipe for a nutritional food product made from natural ingredients; and an insulated tote sized to hold food products made with the mold for transporting the food products to a recipient.

Another aspect is a method of providing nutritional food products to a recipient, the method comprising: reading a recipe card including a recipe for making a food product; preparing ingredients according to the recipe; placing the prepared ingredients into cavities of a flexible mold; inserting a stick into the food product in each cavity; cooking or freezing the food product; placing the food product into a thermally insulated tote; and delivering the food product to the recipient.

### BRIEF DESCRIPTION OF THE DRAWINGS

FIG. 1 is a schematic diagram of a nutritional system according to one embodiment of the present disclosure.

FIG. 2 is a perspective view of an example tote of the system shown in FIG. 1.

FIG. 3 is a front view of the tote shown in FIG. 2.

FIG. 4 is a perspective view of an example thermal pack of the system shown in FIG. 1.

FIG. 5 is a perspective view of an example mold of the system shown in FIG. 1.

FIG. 6 is a perspective view of a bottom of the mold shown in FIG. 5.

FIG. 7 is a top view of the mold shown in FIG. 5.

FIG. 8 is a side view of the mold shown in FIG. 5.

FIG. 9 is a top plan view of plurality of sticks of the system shown in FIG. 1.

FIG. 10 is a schematic diagram of an example instruction booklet of the system shown in FIG. 1.

FIG. 11 is a schematic diagram of example recipe cards of the system shown in FIG. 1.

FIG. 12 is a schematic diagram of example recipe cards of the system shown in FIG. 1.

FIG. 13 illustrates example ingredients of the system shown in FIG. 1.

FIG. 14 is a perspective view of a food product of the system shown in FIG. 1.

FIG. 15 is a perspective view of an example wrapped package of the system shown in FIG. 1.

FIG. 16 is a schematic diagram of an instruction page of the instruction booklet shown in FIG. 10.

FIG. 17 is a schematic diagram of another example instruction page of the instruction booklet shown in FIG. 10.

FIG. 18 is a schematic diagram of another example instruction page of the instruction booklet shown in FIG. 10.

FIG. 19 is a schematic diagram of another example instruction page of the instruction booklet shown in FIG. 10.

FIG. 20 is a schematic diagram of another example instruction page of the instruction booklet shown in FIG. 10.

FIG. 21 is a schematic diagram of another example instruction page of the instruction booklet shown in FIG. 10.

FIG. 22 is a schematic diagram of an example mindful eating instruction page of the instruction booklet shown in FIG. 10.

FIG. 23 is a schematic diagram of another example mindful eating instruction page of the instruction booklet shown in FIG. 10.

FIG. 24 is a perspective view of the system according to one embodiment of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

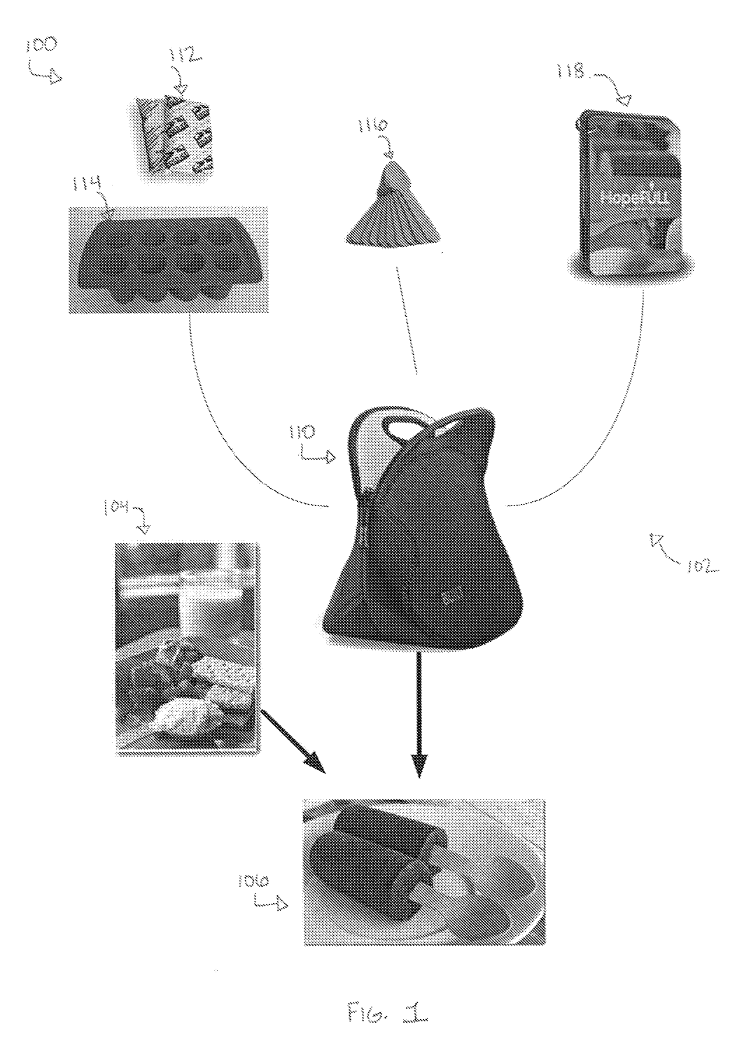

FIG. 1 is a schematic diagram of a nutritional system 100 that can provide a nutritious food product for a person, such as a person undergoing chemotherapy, suffering from dysphagia, or otherwise being in need of a nutritious meal that is easy to consume.

Nutritional system 100 includes a food product kit 102, food product ingredients 104, and food products 106. The kit 102 provides everything needed to produce nutritious food products 106, except that some embodiments of kit 102 do not include product ingredients 104, a thermal pack 112, and an optional cooling source for freezing the product ingredients. In other embodiments, product ingredients are included with kit 102.

In an example embodiment, kit 102 includes tote 110, thermal pack 112, mold 114, sticks 116, instruction booklet 118, and recipe cards 120. These and other possible components of kit 102 are described in more detail below.

Food product 106 can be made utilizing kit 102. An example method of making food product 106 involves at least some of the following steps. The components of kit 102 are removed from tote 110. A recipe card 120 is read to identify necessary ingredients for making food product 106. The necessary ingredients are obtained, such as from a grocery store. Recipe card 120 can also include instructions for processing the ingredients, such as cutting, chopping, crushing, mixing, heating, melting, blending, stirring, or otherwise combining or processing the ingredients into the form indicated on the recipe card 120. Recipe cards 120 may further include at least one narrative 121. An example of narrative 121 is an original poem related to the recipe.

After the ingredients have been obtained and processed, the ingredients are placed into cavities of mold 114. Sticks 116 are partially inserted into the mold 114 cavities and into the ingredients contained in the cavities. The assembly is then cooled, such as by placing the assembly into a freezer.

Once the food product has sufficiently cooled, the food product 106 becomes solid and can be removed from the freezer. In some situations, the food product 106 may need to be transported prior to consumption. Tote 110 can be used to store food product 106 during transportation. After removing the assembly from the freezer, the entire assembly can be placed into the tote 110 with one or more thermal packs 112 to keep the food product 106 cool while it is transported, and thereafter consumed. Alternatively, the food product 106 can be removed from mold 114, placed into separate bags (such as plastic resealable bags), placed into tote 110 with thermal packs 112, and delivered to the person for consumption. If desired, some of food products 106 may again be placed into a freezer for storage and subsequently consumed. Another possible alternative is that one or more of the food products 106 can be removed from mold 114 and then consumed without transporting the food product 106 in tote 110.

Some embodiments include more or fewer components than those shown in FIG. 1. For example, some embodiments do not include narrative 121 cards. In yet other embodiments, kit 102 includes storage bags for storing prepared food products 106. An example of a storage bag is a natural eco-friendly bag, free of plasticizers, phthalates or bisphenol-A. In some embodiments the storage bags are made entirely from recycled materials. Other embodiments of kit 102 are discussed herein.

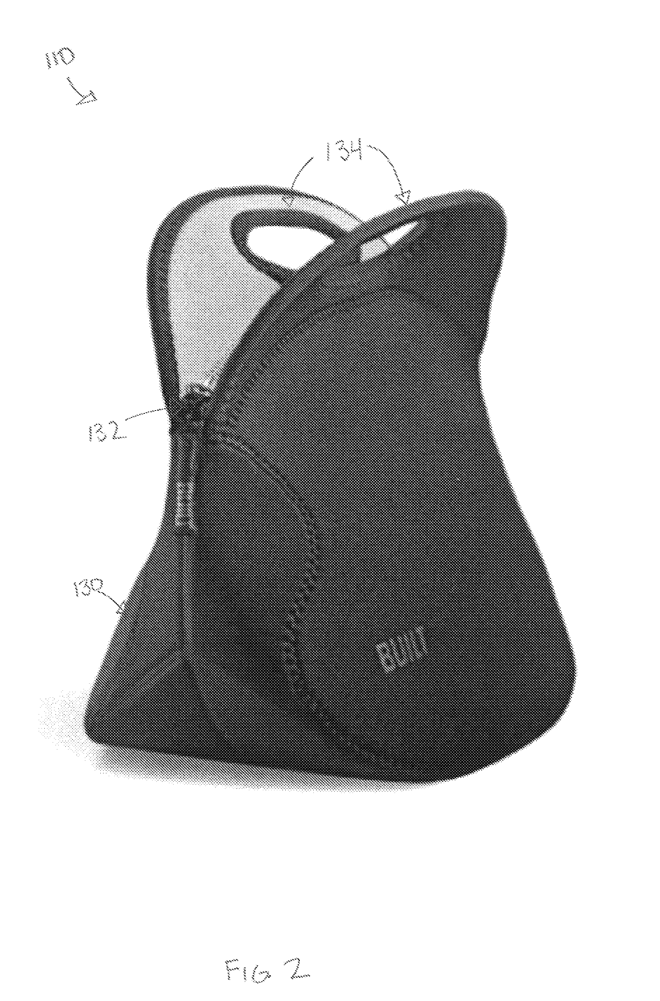

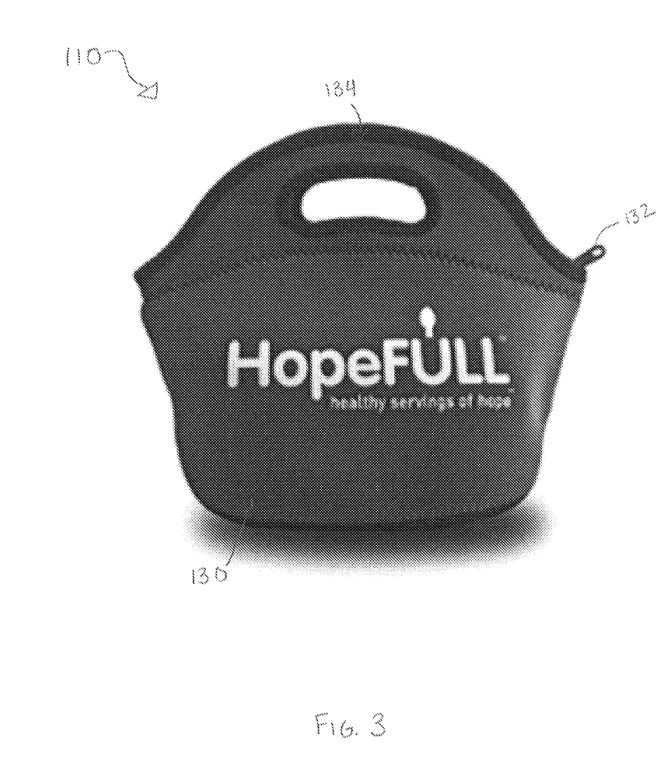

FIGS. 2-3 illustrate an example tote 110. FIG. 2 is a perspective view and FIG. 3 is a front side view. A variety of tote 110 shapes and configurations are used in different embodiments, but one example embodiment includes a body 130, closure 132, and handle 134.

In this example, body 130 is made of a flexible material that is shaped to form a container for storing portions of nutritional system 100. An example of a suitable material for body 130 is neoprene, such as having a thickness from about 2 mm to about 6 mm, and preferably about 4 mm. In some embodiments the material is free of polyvinyl chloride (PVC) and bisphenol A (BPA). In some embodiments, the material is the same as or similar to a stretchy material used for wetsuits. In some embodiments, the material has insulating properties, such as sufficient to maintain the food product at a desired temperature for 2-3 hours, depending on external temperatures and what thermal pack 112 is used.

In some embodiments, the body 130 has a lightweight and stylish design. In this example, the shape of body 130 is formed by cutting pieces of materials to the desired shape, and sewing or otherwise fastening edges of the pieces together. Body 130 is formed to have an opening to provide access to portions of nutritional system 100 that are contained therein. Some embodiments include a logo or other text or graphics on the exterior of body 130.

Closure 132 is provided to open or close the opening of body 130. When closure 132 is in the open position, a user can access the contents within body 130. When closure 132 is in the closed position, the contents are enclosed within body 130. An example of closure 132 is a zipper. Other embodiments utilize one or more other fasteners, such as buttons, snaps, clips, bands, hook and loop fasteners, straps, etc. Yet other embodiments do not include closure 132.

Handle 134 extends from body 130 to provide a convenient place to grasp tote 110 with a hand. In this example, handle 134 is formed of extended portions of body 130, with orifices formed therein that are sized to receive a hand. A variety of different handle configurations can be used in other embodiments, such as including one or more straps, cords, ropes, bands, and chains, or other handle configurations. In addition, some embodiments do not include a handle.

As one example, the tote 110 has external dimensions having a width in a range from about 10 to about 16 inches, a height in a range from about 8 to about 12 inches, and a depth in a range from about 4 to about 10 inches. Other embodiments have other dimensions.

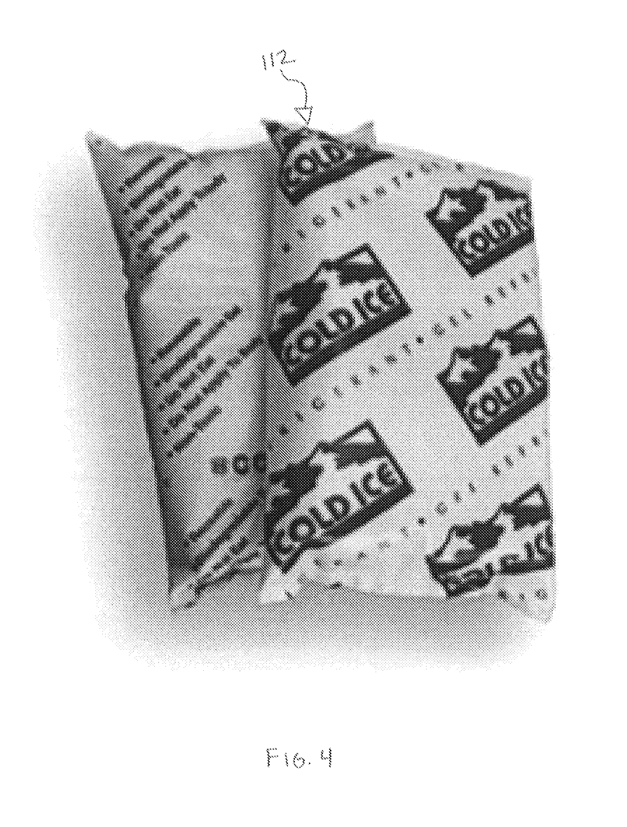

FIG. 4 illustrates an example thermal pack 112. In some embodiments, kit 102 includes thermal pack 112. The thermal pack 112 is used, for example, to keep ingredients 104 and/or food product 106 warm or cool during transportation in tote 110. One example of a thermal pack 112 is a reusable cooling pack. The cooling pack can be placed, for example, into a cool location, such as within a freezer for cooling, and then placed into the tote 110 to keep the contents within the tote 110 at a cool temperature for a period of time. The cooling pack includes, in some embodiments, a food-safe polyethylene film to enclose non-toxic cooling substance therein. An example of a cooling substance is a refrigerant gel material. Another example of a cooling substance is ice.

Another example of a thermal pack 112 is a heating pack, such as a microwaveable heating pack. Some embodiments are configured to be heated in an oven. Another example of a heating pack is a battery powered pack including a heating element. The heating pack can be used to keep contents within the tote 110 at a warm temperature for a period of time.

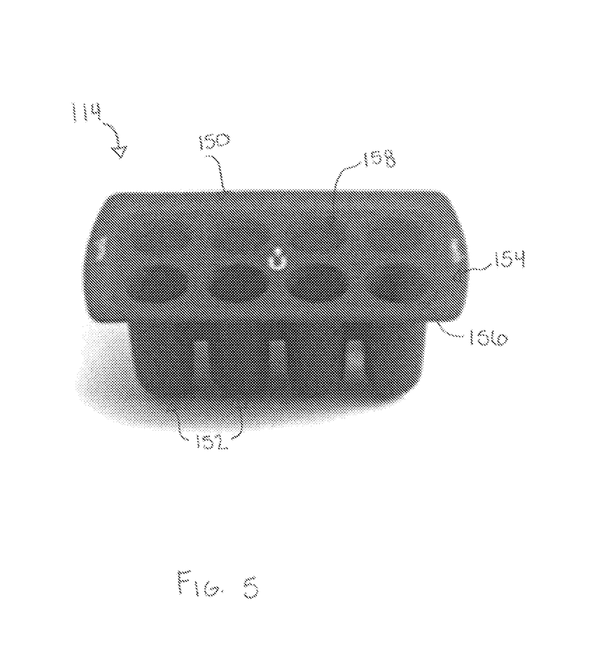

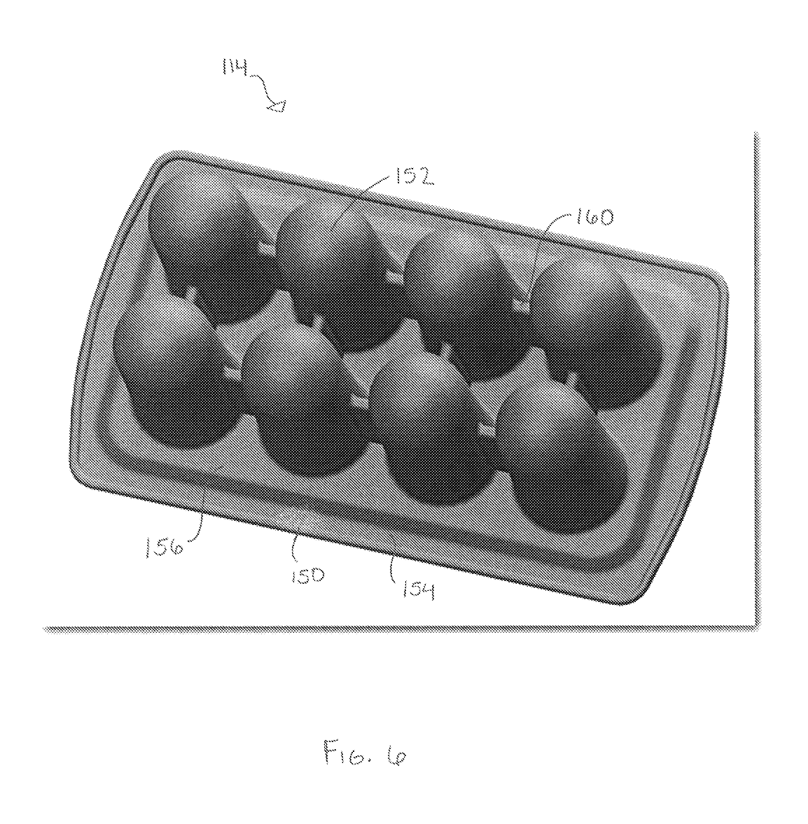

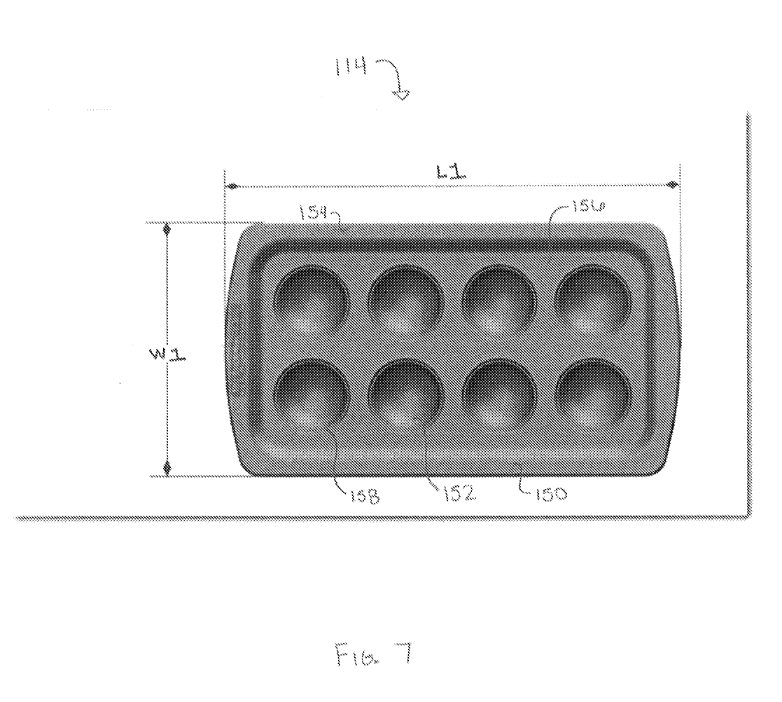

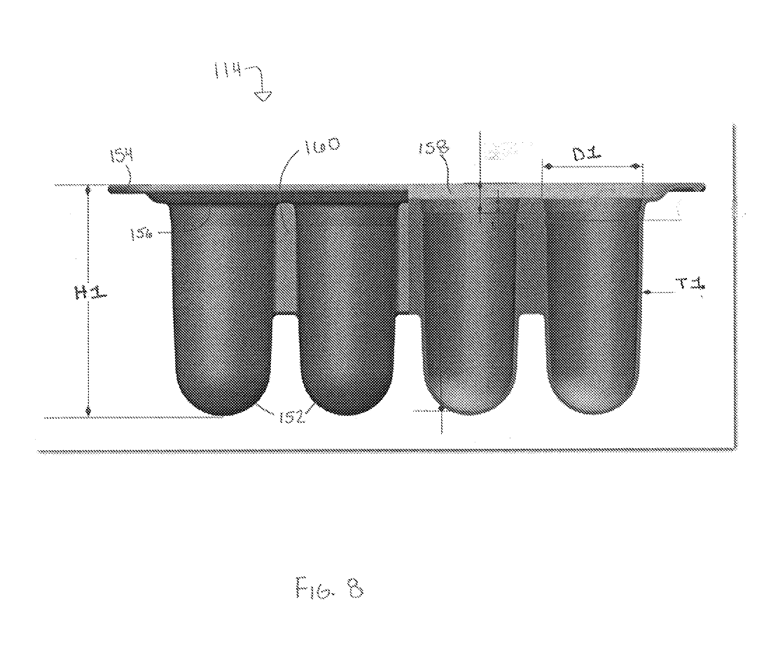

FIGS. 5-8 illustrate an example mold 114. FIG. 5 is a perspective view of a side and top of mold 114. FIG. 6 is a perspective view of a bottom of mold 114. FIG. 7 is a top view of mold 114. FIG. 8 is a side view with the right side being shown in cross-section. In this example, mold 114 includes tray 150 and a plurality of food product forming cavities 152.

In some embodiments, mold 114 is made of a flexible material, such as food grade silicon. In some embodiments, the material is BPA, PVC, and phthalate free. In some embodiments, mold 114 has unbreakable, easy release, and no-stick properties. In some embodiments, mold 114 is dishwasher safe, microwave safe, oven save, and freezer safe. In some embodiments, mold 114 is usable in a range of temperatures from −40° C. to 230° C. In some embodiments, mold 114 is easy to clean. To clean, for example, the mold 114 can be rinsed and wiped clean and placed into a dishwasher.

Tray 150 forms an upper portion of mold 114, and includes raised edge 154 and recessed surface 156. The raised edge 154 is elevated above recessed surface 156. When liquid ingredients are inserted into cavities 152, some of the liquid may fall on recessed surface 156. Raised edge 154 helps to contain the liquid to the recessed surface 156 to reduce spilling of the liquid off of the mold 114. Raised edge 154 also forms handles for grasping mold 114 with hands.

Tray 150 includes a plurality of orifices 158 that define orifices for cavities 152 that extend from tray 150. As one example, orifices 158 have a circular shape. Other embodiments have other shapes. The shapes and sizes of cavities 152 are selected to provide food products that are sized for people having sore mouths or mouths with limited movement.

Cavities 152 are sized and shaped to define the desired shape and dimensions of food products 106. In the illustrated embodiment, cavities 152 have a cylindrical shape with a rounded end. In this example, mold 114 includes eight cavities 152. Other embodiments include other numbers of cavities 152, such as one, two, three, four, five, six, seven, eight, nine, ten, eleven, twelve, or more cavities 152. In some embodiments cavities 152 are arranged in rows, such as one, two, three, or more rows.

Referring to FIG. 6, supports 160 are provided in some embodiments to provide added strength and stability to food product forming cavities 152.

Referring to FIGS. 7 and 8, dimensions of an exemplary embodiment are shown. In this exemplary embodiment, the mold 114 has a length L1. L1 is typically in a range from about 100 mm to about 300 mm, and preferably in a range from about 150 mm to about 250 mm. W1 is a width of mold 114. W1 is typically in a range from about 50 to about 200 mm, and preferably in a range from about 100 mm to about 130 mm. H1 is a height of mold 114. H1 is typically in a range from about 40 mm to about 120 mm, and preferably from about 60 to about 100 mm. D1 is a diameter of cavity 152 at orifice 158. D1 is typically in a range from about 15 mm to about 50 mm, and preferably from about 30 mm to about 40 mm. Cavities 152 have a volume in a range from about 1 oz. to about 3 oz., and preferably from about 1.5 oz. to about 2.5 oz. T1 is a thickness of mold 114 material, such as in cavity 152. T1 is typically in a range from about 0.5 mm to about 3 mm, and preferably in a range from about 1 mm to about 2 mm. Other embodiments include other dimensions.

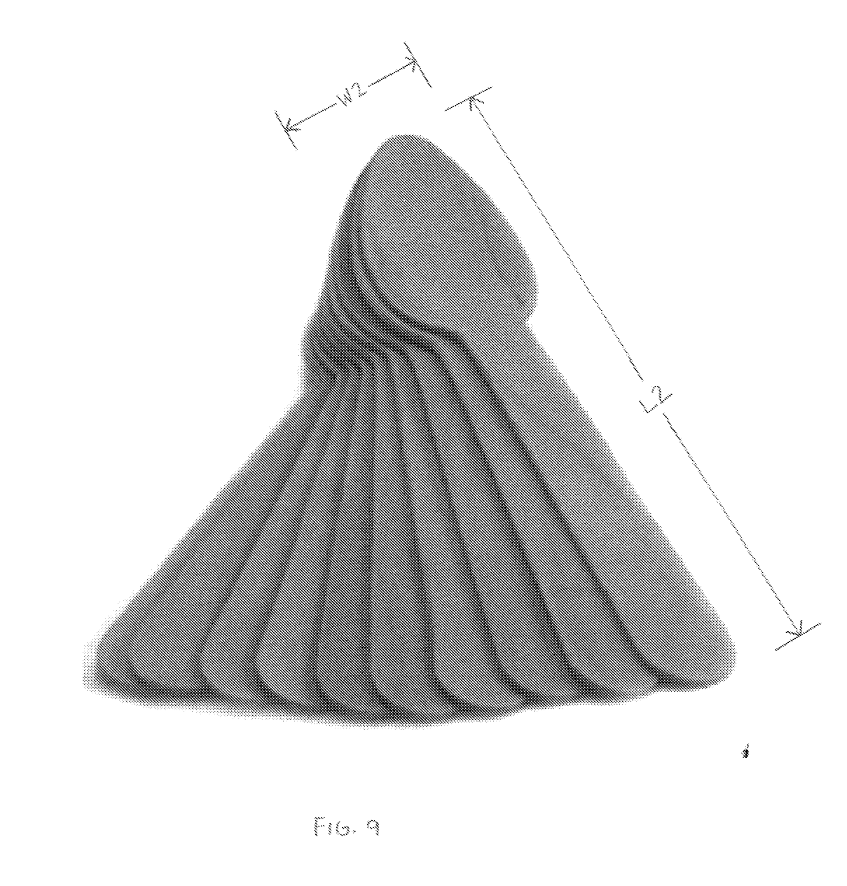

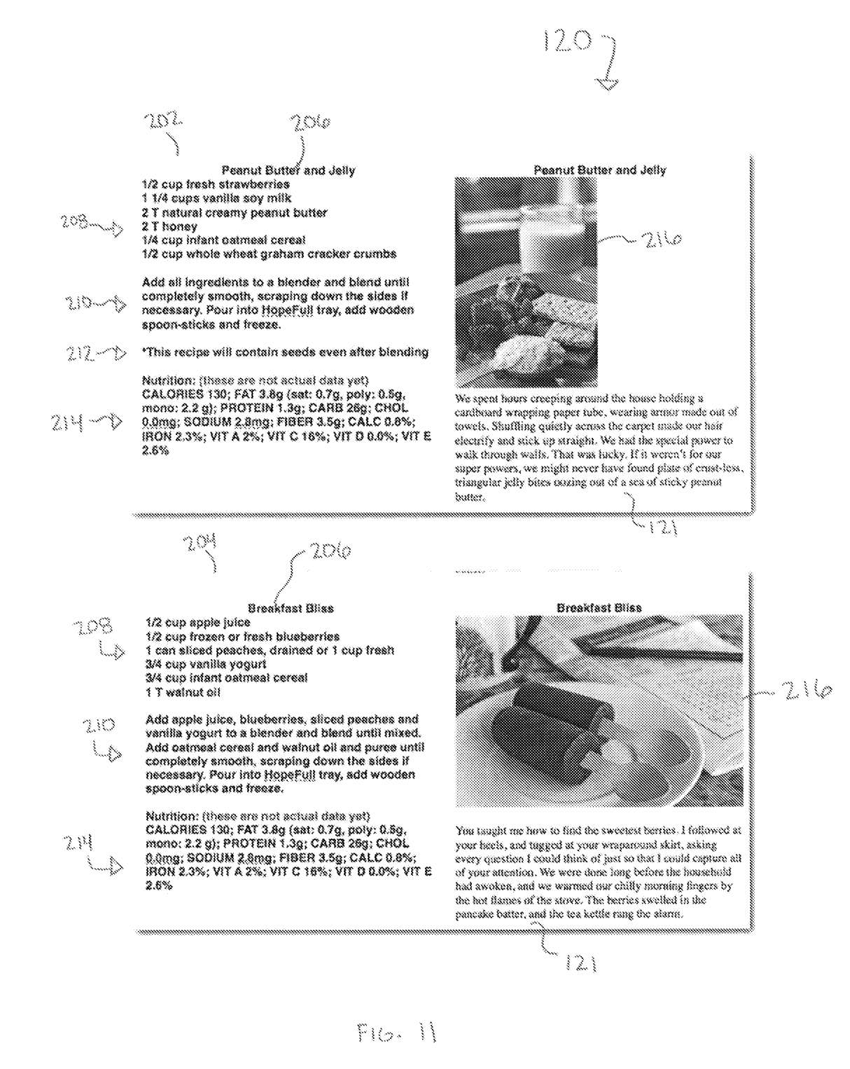

FIG. 9 is a top plan view of an example of a plurality of sticks 116. When forming a frozen food product 106, stick 116 can be inserted into cavity 152 along with the food product mix prior to freezing. After freezing, the stick 116 forms a handle that can be used to hold the frozen food product 106 while eating. If a warm food product is made, stick 116 acts as a utensil, such as a spoon, that can be used to scoop bite-sized portions of the food product to deliver the food product to the mouth. In this example, stick 116 is made of wood, such as grade-A birch wood. Other embodiments include other materials, such as plastic, metal, etc. In some embodiments, stick 116 is biodegradable and food-safe. Another example embodiment of stick 116 is shown in recipe card 204, shown in FIG. 11.

Stick 116 has a length L2. L2 is typically in a range from about 2 inches to about 6 inches, and preferably from about 3 inches to about 5 inches. W2 is the width of stick 116. A width of at least a portion of stick 116 is sized to fit within cavity 152, such as less than diameter D1, shown in FIG. 8. W2 is typically in a range from about 0.3 inches to about 1.5 inches, and preferably from about 0.5 inches to about 1 inch. In some embodiments, kit 102 includes a plurality of sticks 116, such as a pack of 80 sticks. Other quantities of sticks 116 are included in other embodiments.

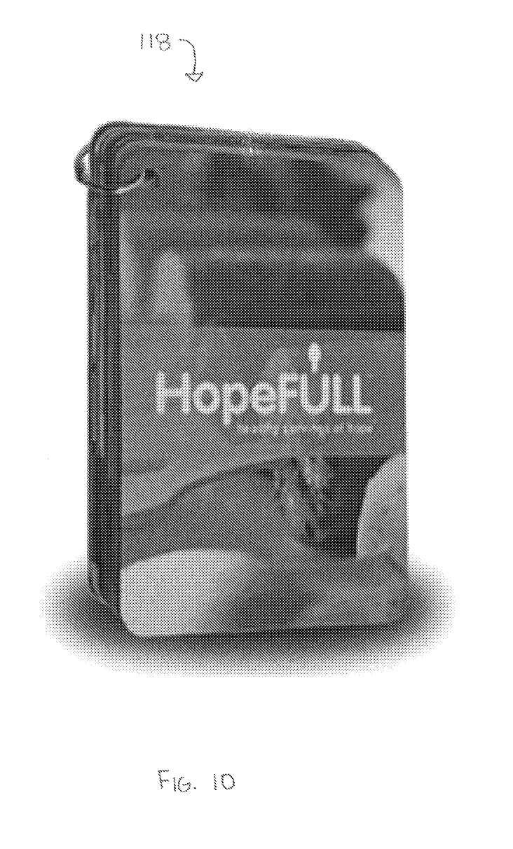

FIG. 10 is a schematic diagram of an example instruction booklet 118. Instruction booklet 118 is typically a plurality of cards or pieces of paper designed to include instructions for how to prepare food products 106 from ingredients 104 using kit 102.

In some embodiments, instruction booklet 118 is preprinted with instructions as part of the kit 102. The instructions can include, for example, an estimated time required to prepare the food product 106, a number of servings of food product 106 that will be made; a list of ingredients that are included with the kit 102, a list of ingredients 104 that are not included with the kit and must be separately obtained, and step-by-step directions for preparing and making food product 106, and instructions for transporting the food product 106 to the recipient. In another possible embodiment, instruction booklet 118 describes the overall contents and use of kit 102. In yet another embodiment, instruction booklet 118 describes various eating exercises.

FIG. 11 illustrates one embodiment of recipe cards 120. Two exemplary cards 120 are shown, including card 202 and card 204. Some embodiments include a plurality of recipe cards, such as ten, twenty, or other quantities of recipe cards 120. Recipe cards 120 are typically made or card stock or other paper or board materials. Each recipe card 120 includes one or more printed recipes that can be used to make food products 106. The recipes, in some embodiments, are designed to please discriminating palettes and soothe sore mouths, and to create food products 106 that are wholesome and tasty, but do not use strong flavors or aromas. Recipes often describe steps including processing, blending, freezing, or baking.

Some embodiments of recipe cards 120 includes recipe name 206, list of ingredients 208, preparation directions 210, warnings 212, nutritional facts 214, a photograph 216, and a narrative 121 relating to the recipe. In one embodiment, narrative 121 can be an original, inspirational poem which can provide the recipient or caregiver with hope when read. In some embodiments, recipe cards are fastened together with a detachable fastener, such as a ring. The recipe cards can be detached from one another, so that a recipe card can be delivered along with a completed food product to the recipient. The recipe card can then be used by the recipient, such as to review the nutritional information for the food product. An example of a detachable fastener is a detachable ring.

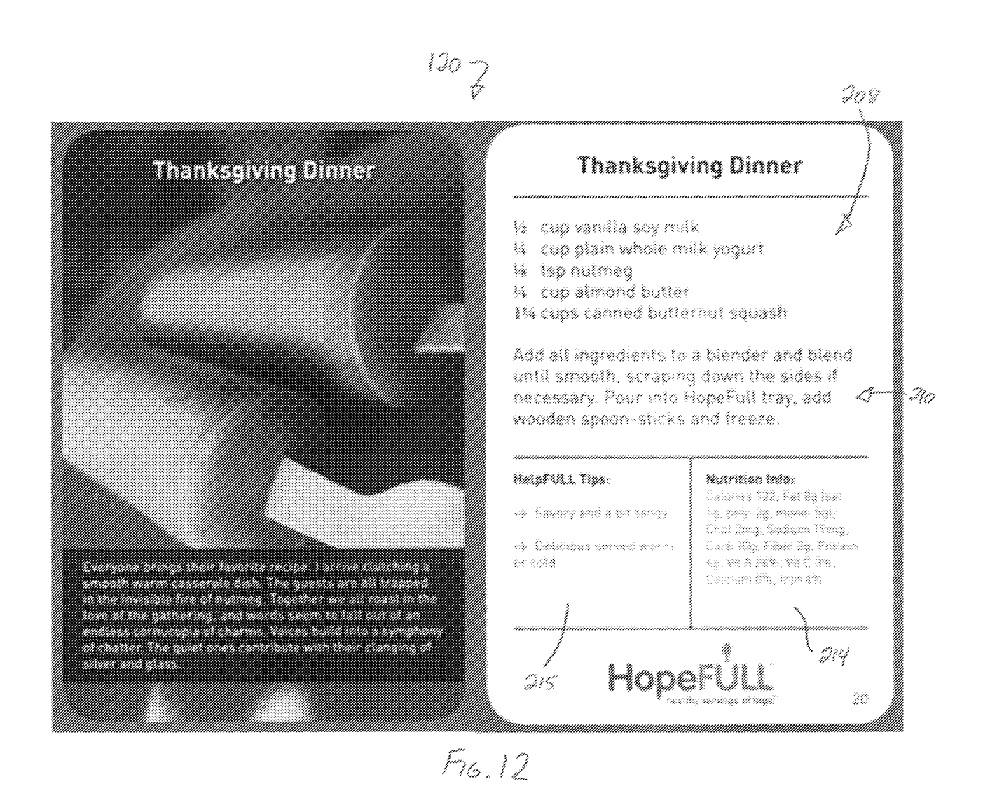

FIG. 12 illustrates another embodiment of a recipe card 120 containing a list of ingredients 208, preparation directions 210, nutritional facts 214 and serving tips 215.

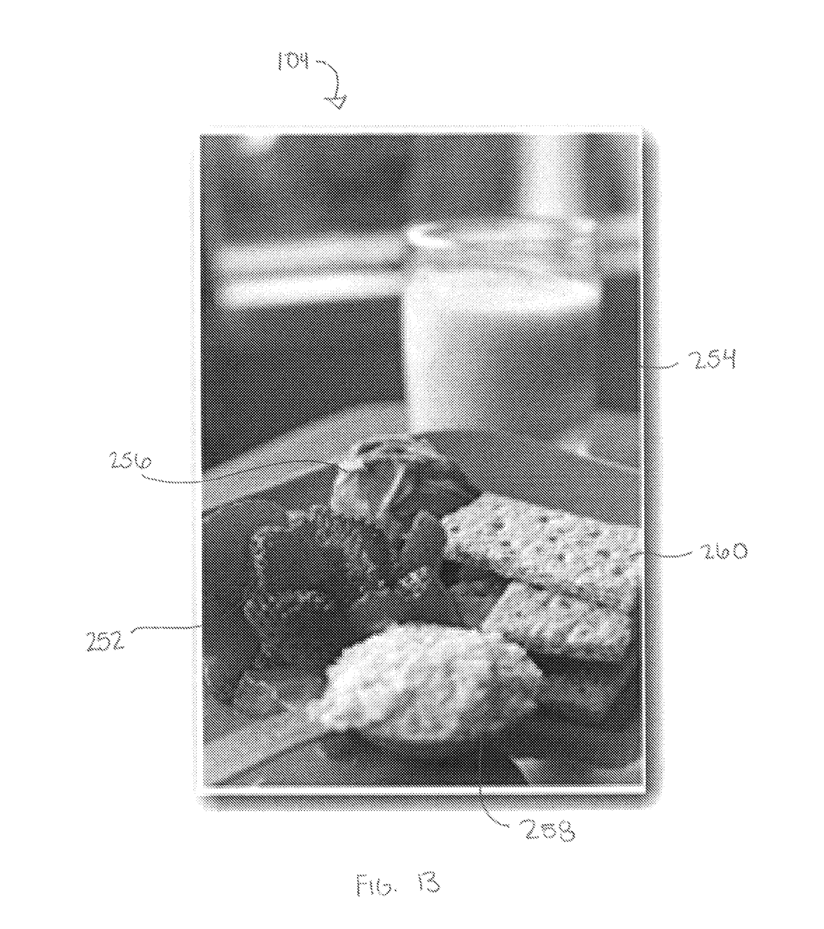

FIG. 13 illustrates example ingredients 104. In some embodiments, at least some of the ingredients 104 for making food product 106 are not included with kit 102. In other embodiments, however, the ingredients are included. FIG. 13 illustrates several of the ingredients 104 used to create a peanut butter and jelly food product 106 using recipe card 202 (shown in FIG. 11). Ingredients 104 include fresh strawberries 252, vanilla soy milk 254, natural creamy peanut butter 256, infant oatmeal cereal 258, and whole wheat graham crackers 260. Other recipes call for other ingredients 104.

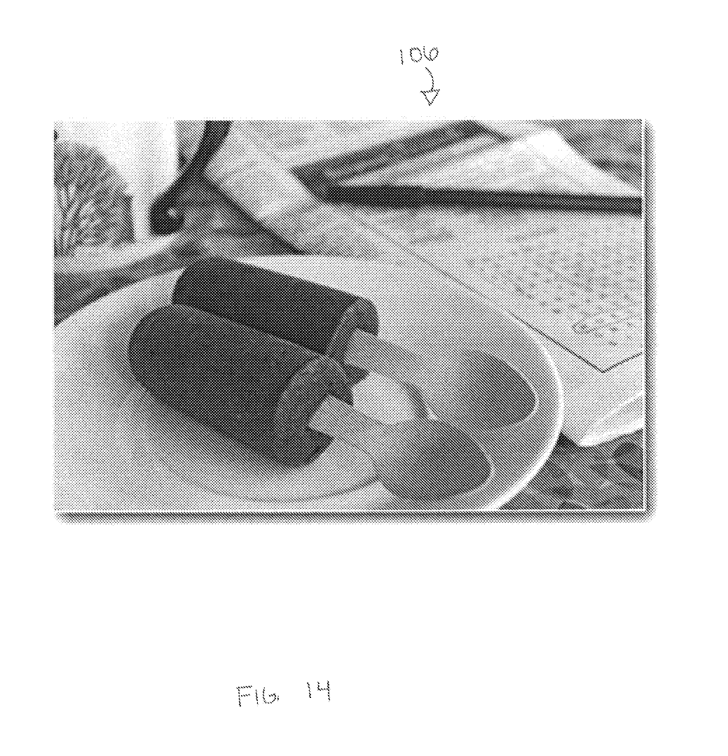

FIG. 14 is a schematic perspective view of example food products 106. After preparing ingredients 104 according to a recipe of a recipe card 120 and forming the food product with mold 114, the food product can be removed from mold 114 and is ready for consumption as illustrated in FIG. 14.

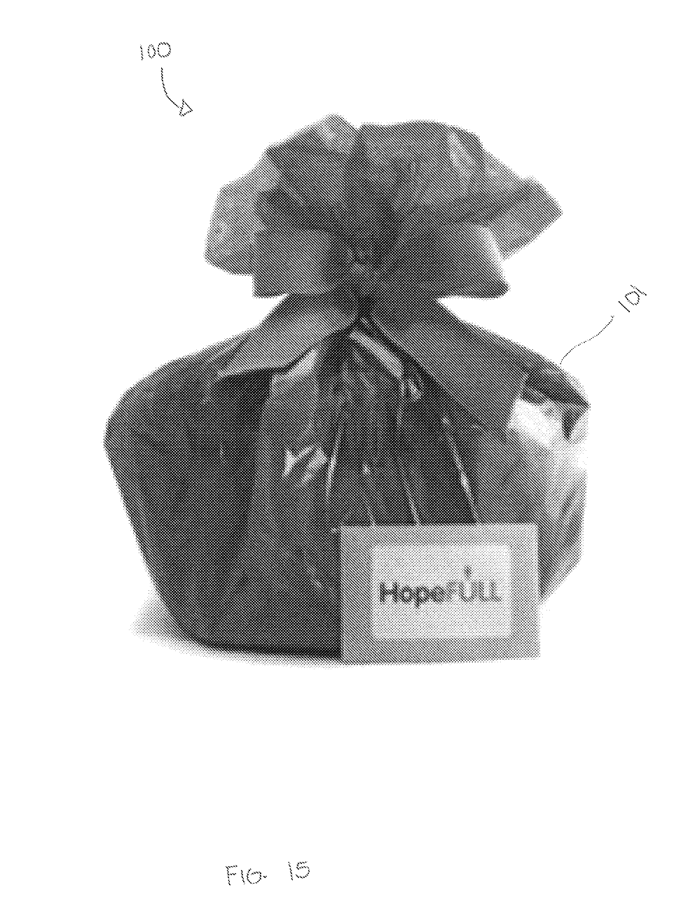

FIG. 15 illustrates one embodiment of an example wrapped package 101 of the nutritional system 100. In this embodiment, the nutritional system 100 is wrapped and ready to be presented as a gift.

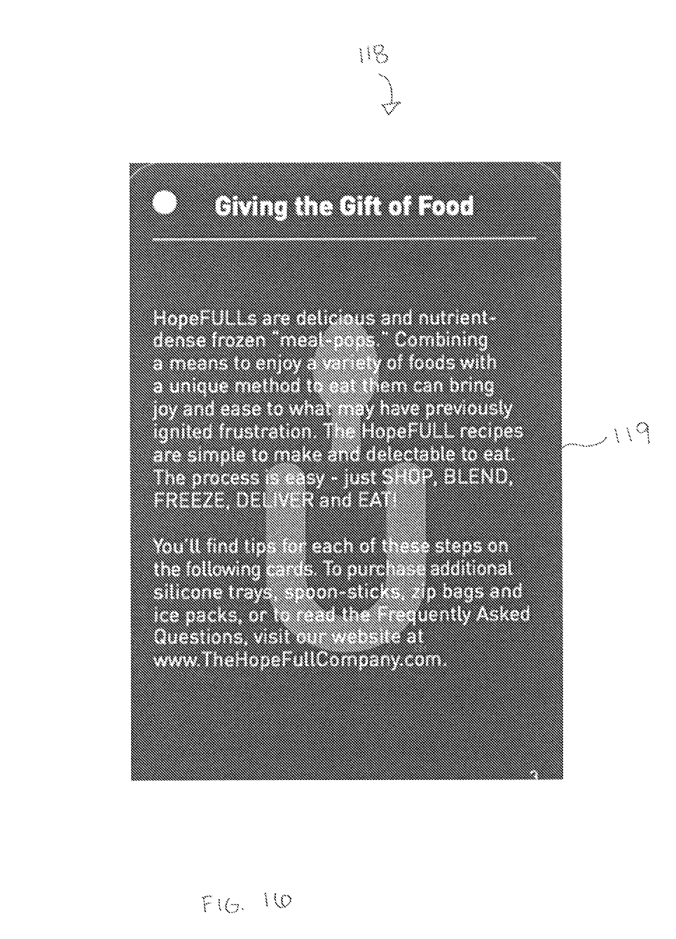

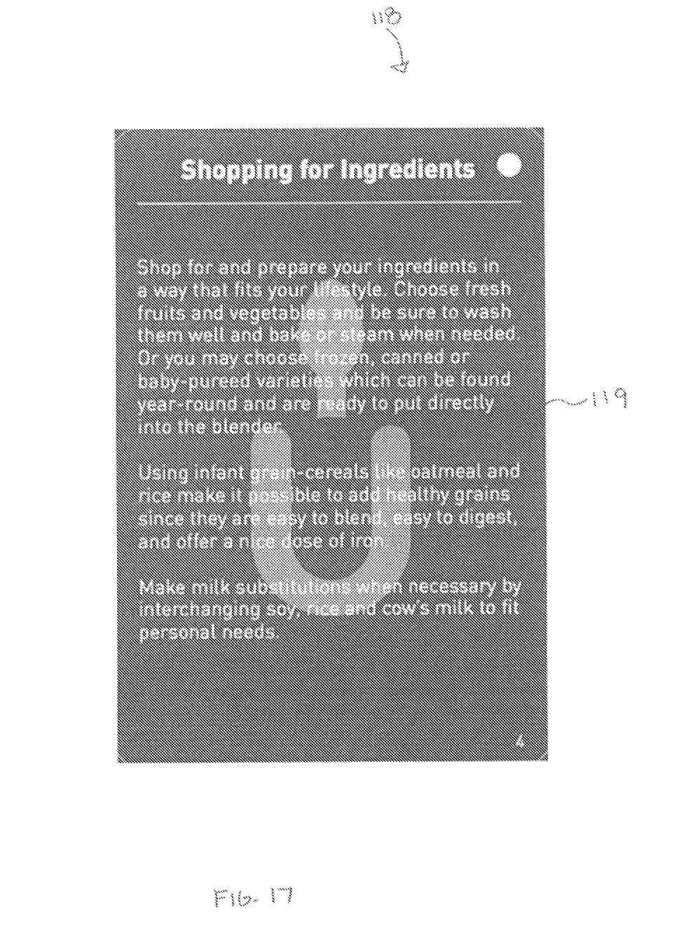

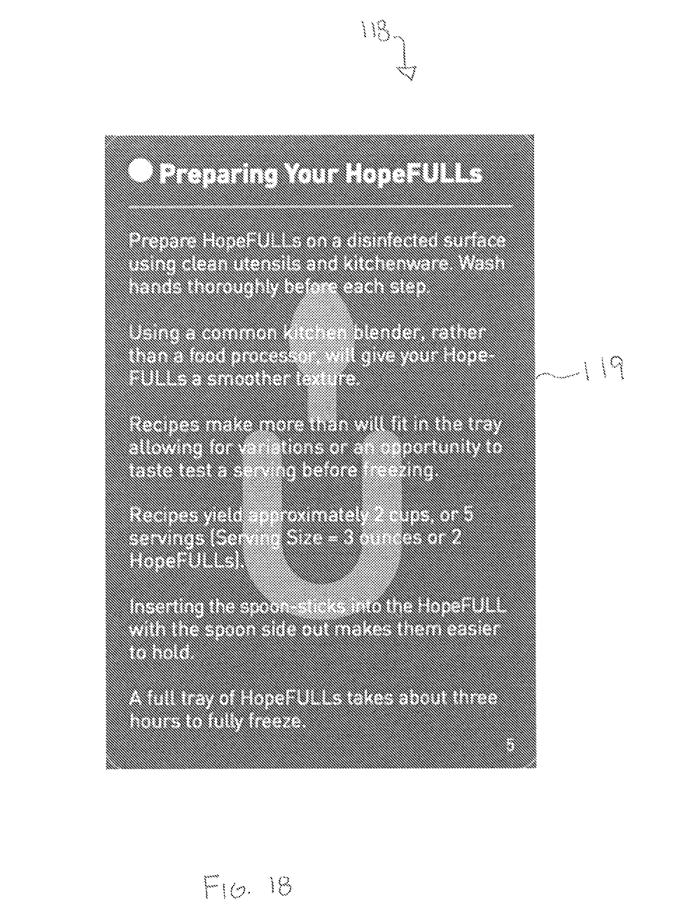

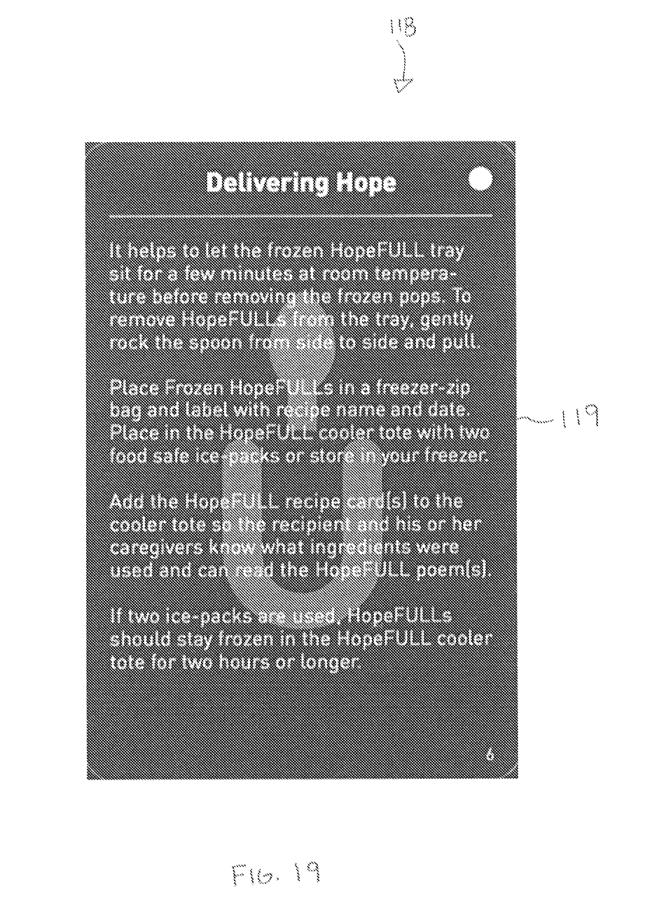

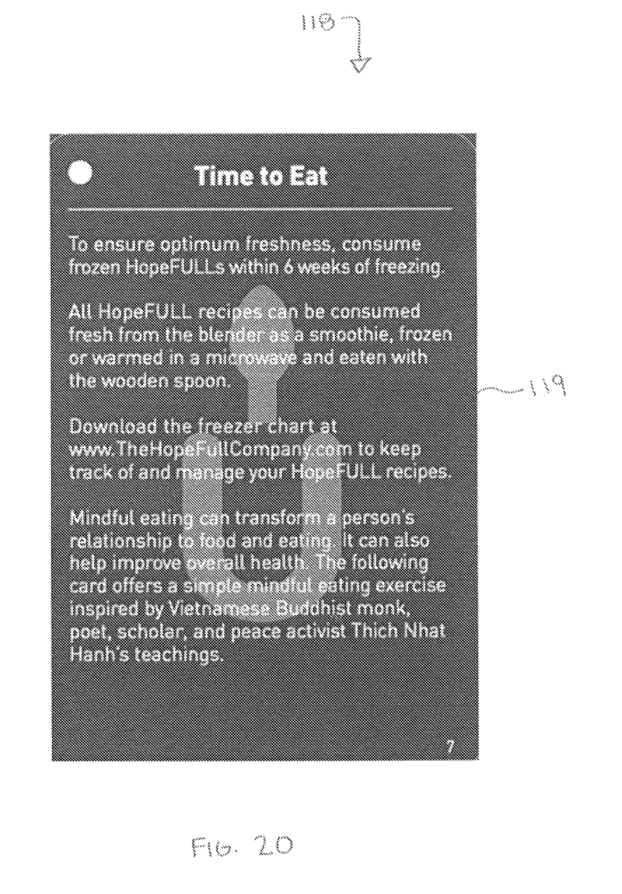

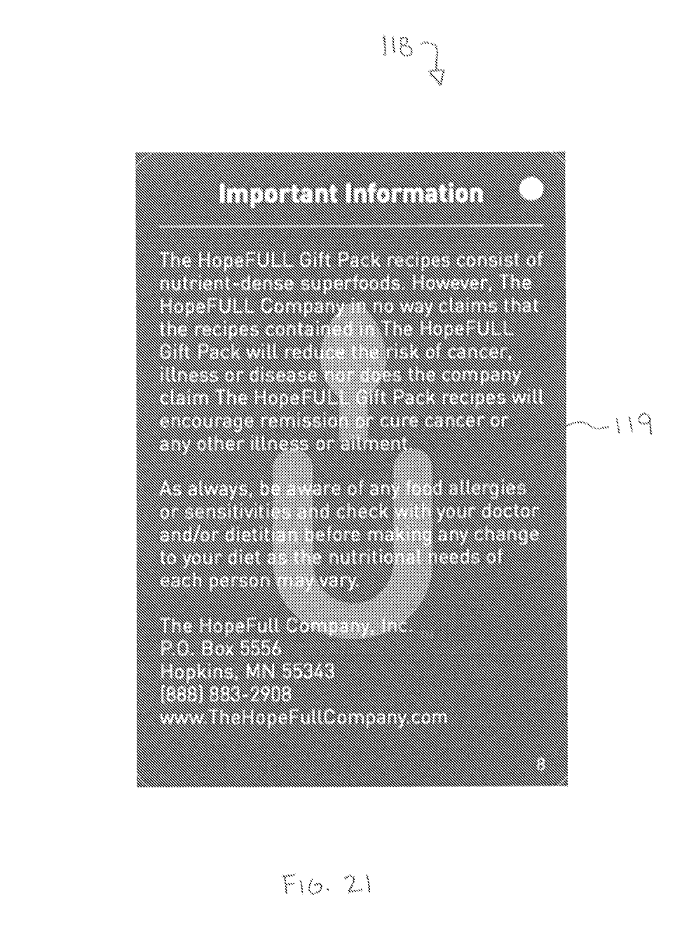

FIGS. 16-21 illustrate one embodiment of the simple eating instructions 119 contained in the instruction booklet 118. These simple eating instructions 119 guide the consumer in selecting ingredients as well as in preparing, packaging, and eating the food.

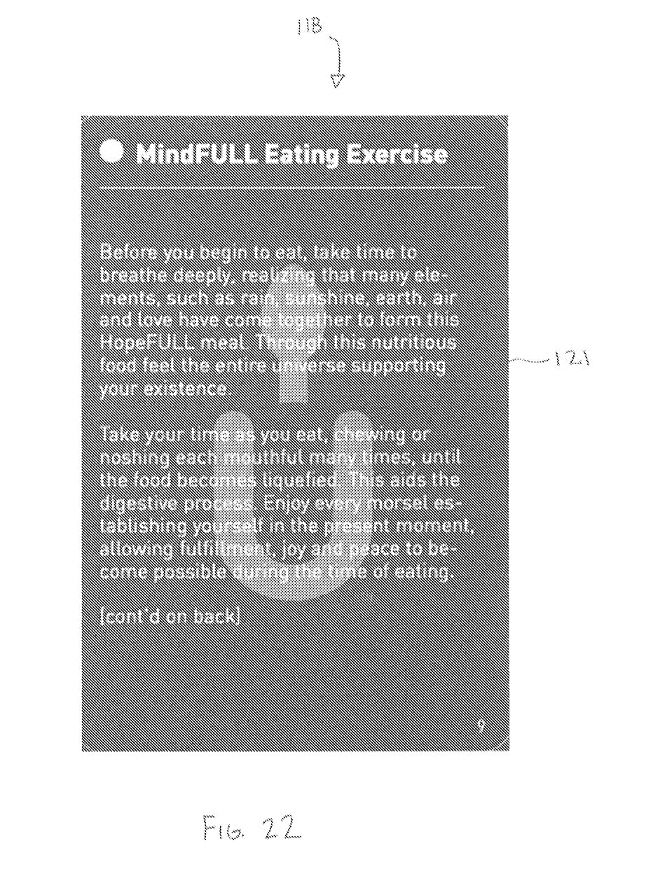

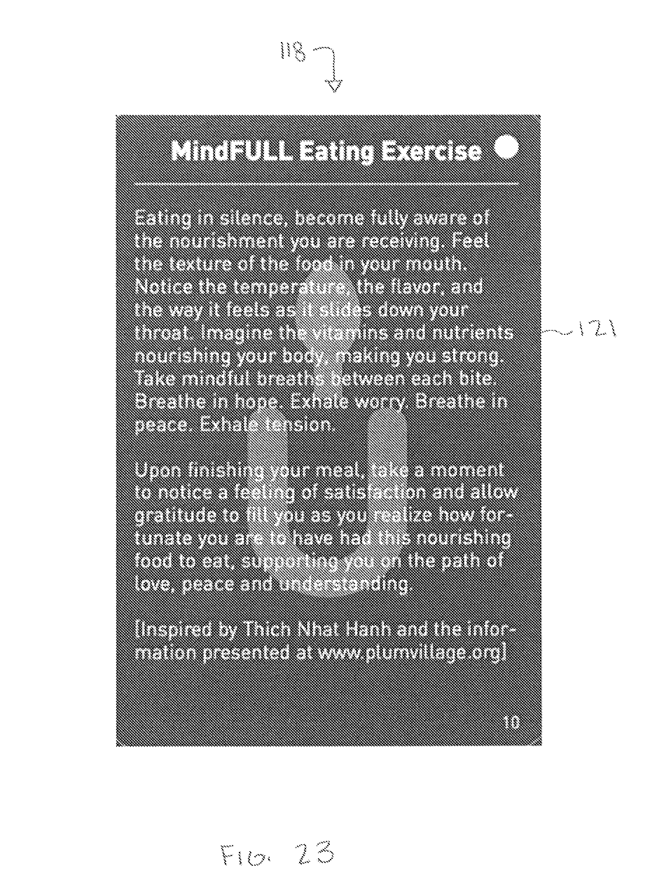

FIGS. 22-23 illustrate one embodiment of the mindful eating instructions 121 contained in the instruction booklet 118. The mindful eating instructions 121 are designed to help the consumer meditate while eating the prepared food. An example of the mindful eating instructions 121 for a greenie pineapple pop, an example food product 106, may be as follows: “Breathe it in. Let it travel through your veins, calming your cells with cool freshness. Where there was tension, there is now only mint. Mint beckons you, pulling you through velvety leaves, down long stems. Mint digs your toes into the loose dirt. Let your toes surrender to the weight. Feel the sun on your hands and forehead. Exhale into the breeze flowing by. Breathe it in.” Other embodiments include different instructions.

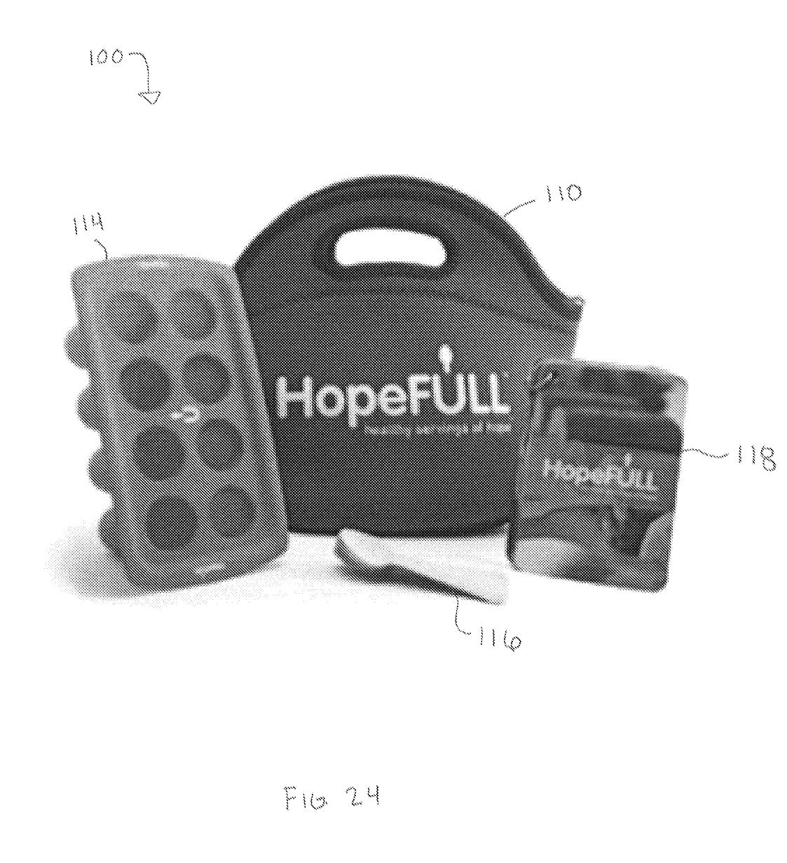

FIG. 24 is another example embodiment of the nutritional system 100 including a tote 110, mold 114, a plurality of sticks 116, and an instruction booklet 118.

An exemplary method of using a kit 102 will now be described. In this example, the consumer purchases a kit 102 as well as any additional add-on products or ingredients. In some embodiments the kit 102 is purchased online through a web site and the kit is delivered to the consumer's home or business by a delivery service.

The consumer then reads the instructions in the instruction booklet 118 and the recipe on recipe card 120 and prepares the food product according to the recipe using the ingredients. The food product is then poured into cavities of the mold 114 along with sticks 116. In the case of a recipe intended to be frozen, the mold 114 and food product is then placed into a freezer until frozen. Alternatively, the food product is placed into the oven or microwave where it is cooked. During or after preparation of the food product, the consumer can choose to recite the narrative 121 printed on recipe cards 120.

Once the food product 106 has frozen or cooked, the consumer then allows the food product 106 to sit at room temperature for a few minutes, and then pulls the sticks 116 to cause the food product 106 to come out of mold 114 through orifices 158. In some instances, it may be necessary for the consumer to gently rock the sticks 116 from side-to-side prior to pulling for easier release. The food products 106 are inserted into a storage bag. Alternatively, food products 106 can remain in mold 114 for delivery or storage.

If food products 106 need to be delivered, food products 106 are placed into tote 110 along with one or more thermal packs 112. A recipe card 120 can be detached from a ring of recipe cards 120, and inserted into the tote 110, if desired. The recipe card can be helpful to the recipient, or the recipient's physician, nurse, or dietician, because the recipe card provides useful information such as a list of ingredients, warnings, nutritional facts, and processing steps. Furthermore, in some examples, recipe cards 120 include narrative 121 which, when read by the recipient, can provide inspiration and hope.

After delivery of the tote 110 to the recipient, the food product 106 can be consumed by the recipient. The recipient can hold the stick 116 while eating a frozen food product 106, or can use stick 116 as a spoon to pick up and eat a warm food product. Alternatively, the product may be eaten fresh from a blender as a smoothie with or without use of the stick 116.

Other methods of using kit 102 are utilized in other embodiments. In addition, aspects of the present disclosure can be used independent of a kit 102 in yet further embodiments.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A nutritional system comprising:
a mold having a plurality of food product forming cavities;
a plurality of sticks sized for insertion into the cavities;
a plurality of recipe cards, each recipe card having printed thereon at least one recipe for a nutritional food product made from natural ingredients; and
an insulated tote sized to hold food products made with the mold for transporting the food products to a recipient.

2. The nutritional system of claim 1, further comprising storage bags sized to store food products therein.

3. The nutritional system of claim 1, further comprising a thermal pack.

4. The nutritional system of claim 1, wherein the mold is made of silicon and includes a tray portion and the plurality of food product forming cavities, wherein each cavity has a substantially circular cross section and a rounded end.

5. The nutritional system of claim 3, wherein the tray portion includes a recessed surface surrounded by a raised edge.

6. The nutritional system of claim 1, wherein the recipe cards are fastened together with a detachable fastener.

7. The nutritional system of claim 1, wherein the recipe cards include a name, a list of ingredients, processing instructions, nutritional information, and a photograph.

8. The nutritional system of claim 7, wherein the recipe cards further include a narrative related to a recipe printed on the recipe card, and further include a warning message providing information about any possible ingredients that may be problematic for certain conditions.

9. The nutritional system of claim 8, wherein the narrative is an original poem related to the recipe.

10. The nutritional system of claim 1, wherein the tote is made of neoprene.

11. A method of providing nutritional food products to a recipient, the method comprising:
reading a recipe card including a recipe for making a food product;
preparing ingredients according to the recipe;
placing the prepared ingredients into cavities of a flexible mold;
inserting a stick into the food product in each cavity;
cooking or freezing the food product;
placing the food product into a thermally insulated tote; and
delivering the food product to the recipient.

12. The method of claim 11, further comprising obtaining ingredients after reading a list of ingredients on the recipe card.

13. The method of claim 11, further comprising reading a healing affirmation card before delivering the food product.

14. The method of claim 11, further comprising reading a narrative on the recipe card before delivering the food product.

15. The method of claim 11, wherein the flexible mold is a silicon mold, and further comprising removing the food product from the mold by pressing upward on one of the cavities.

16. The method of claim 11, further comprising:
detaching the recipe card from a plurality of recipe cards; and
placing the recipe card into the thermally insulated tote for delivery with the food product.
